(19) United States
(12) Patent Application Publication
(10) Pub. No.: US 2004/0238593 A1
(43) Pub. Date: Dec. 2, 2004

(54) Nailer

(75) Inventors: Sueji Tachihara, Ibaraki (JP); Masao Hamada, Ibaraki (JP); Akira Oono, Ibaraki (JP)

Correspondence Address: MCGINN & GIBB, PLLC, 8321 OLD COURTHOUSE ROAD, SUITE 200, VIENNA, VA, 22182-3817, US

(73) Assignee: Hitachi Koki Co., Ltd., Tokyo (JP)

(21) Appl. No.: 10/849,440

(22) Filed: May 20, 2004

(30) Foreign Application Priority Data
May 26, 2003 (JP) P.2003-148443

(51) Int. Cl. B25C 7/00

(52) U.S. Cl. 227/142

(57) ABSTRACT

A wrenching portion provided in an adjuster and employed for assembling is formed at a gripping portion for rotation. The gripping portion is formed in a polygonal shape. In this configuration, the adjuster is decreased in size and weight and its operability of adjusting a driving depth is improved. An undercut portion is removed in a vertical direction and a non-slip rugged portion is provided in only a longitudinal direction so that it can be manufactured in a simple tow-part mold, thereby reducing the production cost.

### BACKGROUND OF THE INVENTION

1. Field of the Invention

The present invention relates to a nailer having a device for adjusting the driving depth of a nail.

2. Description of the Related Art

A previously known method for adjusting the level difference between the head of a nail drived by a nailer and the surface of a member-to-be-drived, i.e. driving depth is proposed in JP-A-10-286784. In this known method, the distance between the tip of a push lever in contact with the member-to-be-drived and the tip of the driver blade at a lower dead point, i.e. the projecting quantity S of the driver blade can be made adjustable. FIG. 7 shows the state where a push lever 15 has been pressed to an member-to-be-drived 12 in order to make a driving operation in a drived status of a nailer having a conventional driving depth adjusting device. The push lever 15, an adjuster 6 and a push lever 16 (hereinafter, these three components are correctively referred to as “a push lever 5”) is raised against the load of a spring 17 which is always urged toward the member-to-be-drived 12, and is further raised in engagement with a switch arm 18. When the touching surface 19 of the push lever 16 is touched to the touching surface 31 of a push lever guide, the push lever 5 stops to ascend. When a switch 3 is pulled, the driver blade 1 is dropped to drive a nail 2, thereby determining the driving depth by a projecting quantity S from the tip 13 of the push lever 15 to the tip 11 of the driver blade 1. Since the push lever 16 is screw-engaged with the adjuster 6, the adjuster 6 is rotated beforehand to expand/contract the push lever 5. In this way, the driver blade projecting quantity S in nail driving is determined, thereby adjusting the driving depth. The adjuster 6, as shown in FIG. 8, includes a wrenching portion 7 employed in assembling and a gripping portion 28 for rotation of the adjuster (hereinafter referred to simply “gripping portion”) employed in adjusting the driving depth. The adjuster 6 is generally manufactured by machining or resin molding.

### SUMMARY OF THE INVENTION

In a nailer having a conventional driving depth adjusting device, the wrenching portion 7 and gripping portion 28 are separately formed in the adjuster 6. Therefore, the adjuster 6 must have a certain length. In the case where the adjuster 6 is manufactured by machining, it cannot be manufactured only by lathing because the wrenching portion 7 must be machined. This leads to the problem of an increase in the production cost. Further, if the diameter of the gripping portion 28 is decreased in order to reduce the size and weight of the adjuster 6, the rugged portion 8 formed on the rotation gripping portion is slippery, thereby making it difficult to rotate the gripping portion 28. On the other hand, in the case where the adjuster 6 is manufactured by resin molding, if the shape of the rugged portion 8 for preventing slippage (hereinafter referred to as a non-slip rugged portion), an undercut portion 9 for reducing the weight located at a central position in the longitudinal direction and a spring housing hole 30 for a steel ball for preventing advertent rotation of the adjuster 6, etc. are taken into consideration, the adjuster cannot be manufactured through simple two-part mold, but must be manufactured through multiple-part mold. This leads to the problem of an increase in the production cost.

An object of this invention is to provide a nailer having a driving depth adjusting device which is compact and lightweight and is easy to operate.

The above object can be attained by the shape of the adjuster in which a wrenching portion is formed at a gripping portion to shorten the entire length of the adjuster; the gripping portion is formed in a polygonal shape to facilitate the rotation with a rugged portion; and no undercut is provided in a longitudinal direction and the rugged portion is provided in only the longitudinal direction so that it can be manufactured in a simple tow-part mold.

### BRIEF DESCRIPTION OF THE DRAWINGS

FIG. 1 is a partial sectional view showing an embodiment of a nailer according to the present invention;

FIG. 2 is a partial sectional view for explaining the driving operation in FIG. 1;

FIG. 3 is a component-exploded view of a nailer adjusting device in FIG. 1;

FIG. 4 is a side view of an adjuster according to this invention;

FIG. 5 is an expanded view of the adjuster shown in FIG. 4 when viewed from arrow C;

FIG. 6 is a sectional view of the adjuster taken in line D-D in FIG. 5;

FIG. 7 is a partial sectional view showing a conventional nailer adjusting device during a driving operation; and

FIG. 8 is a plan view of the adjuster shown in FIG. 7 and a partial sectional view thereof.

### DETAILED DESCRIPTION OF THE PREFERRED EMBODIMENTS

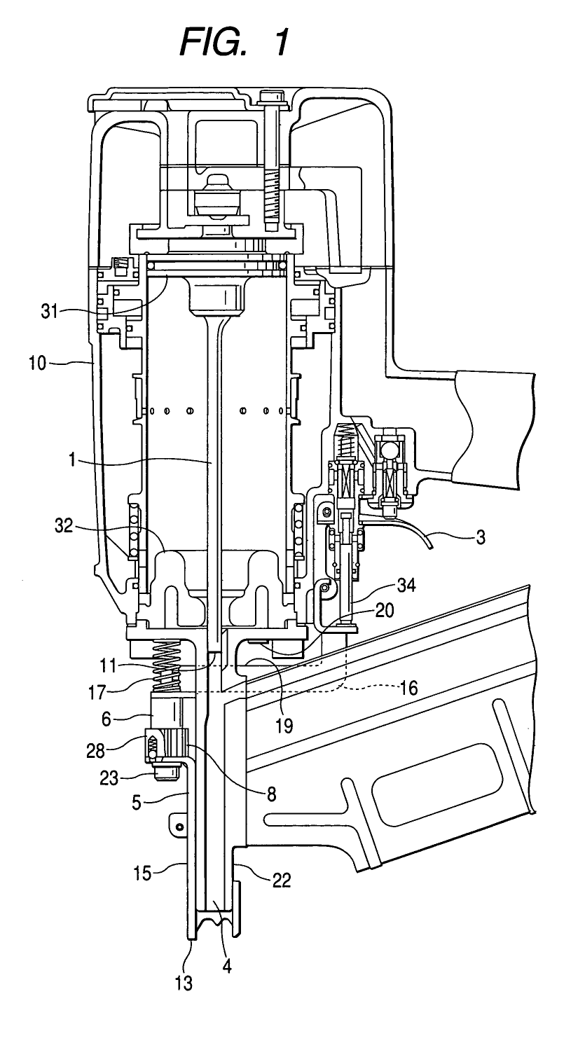

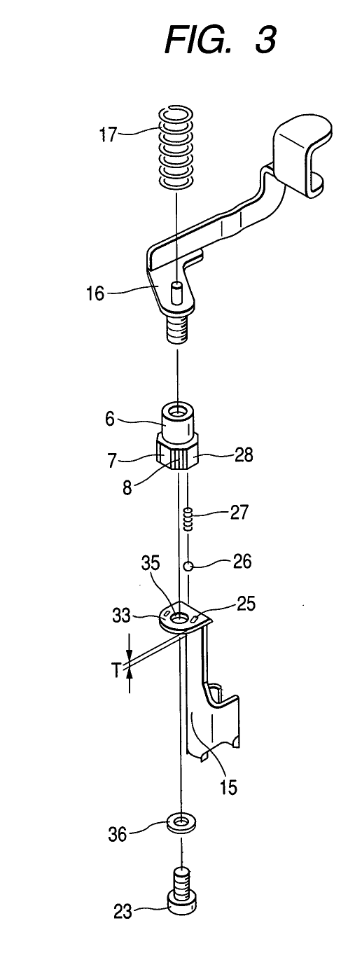

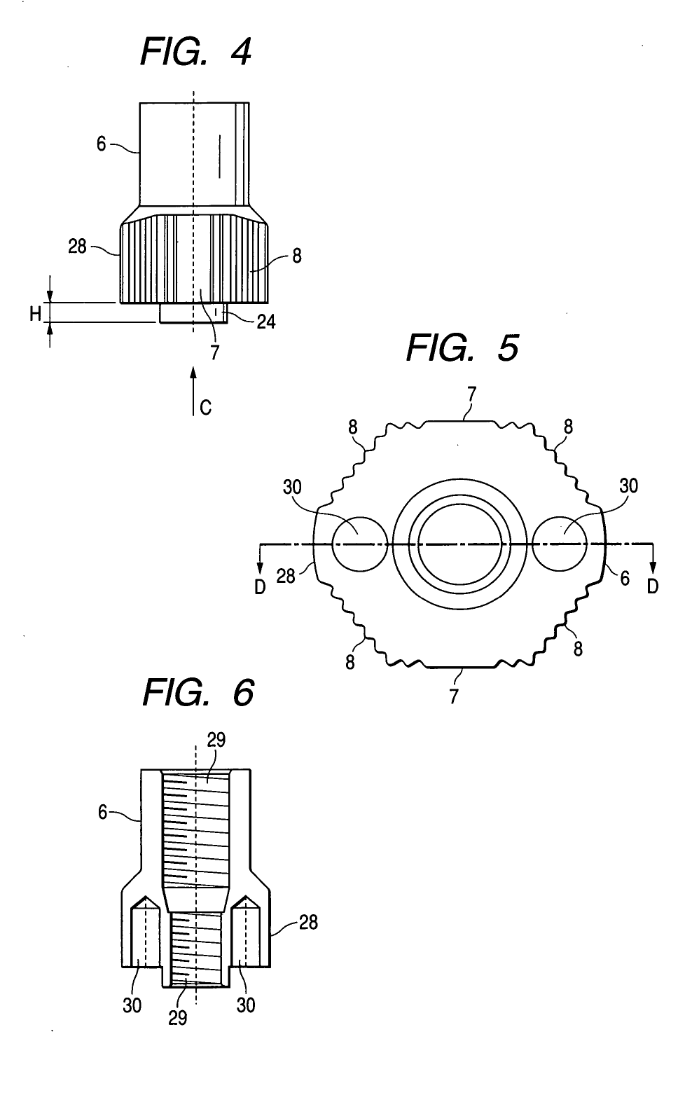

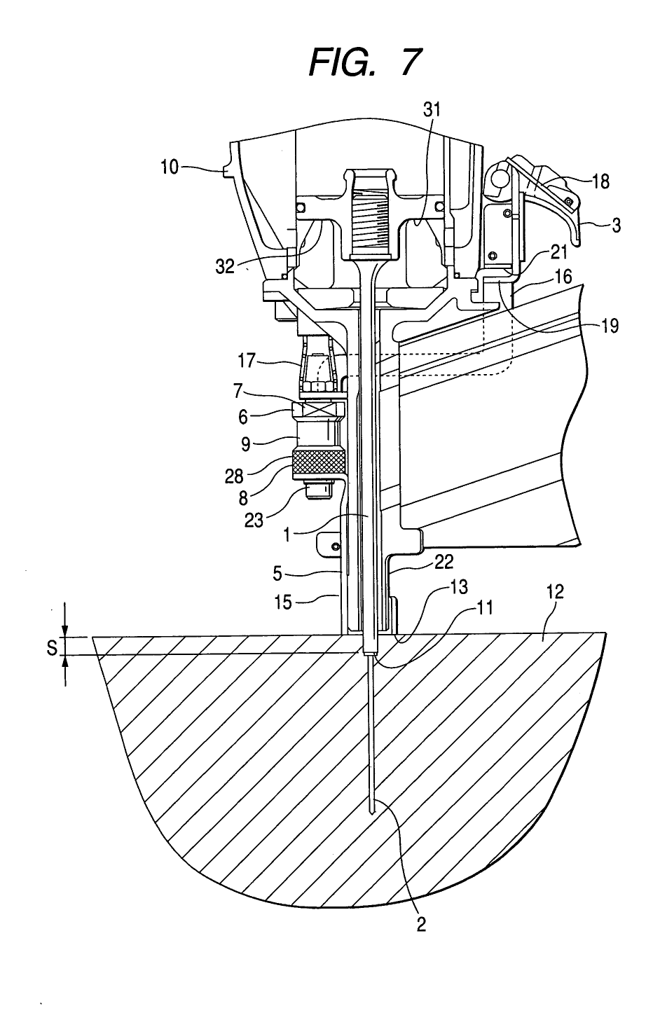

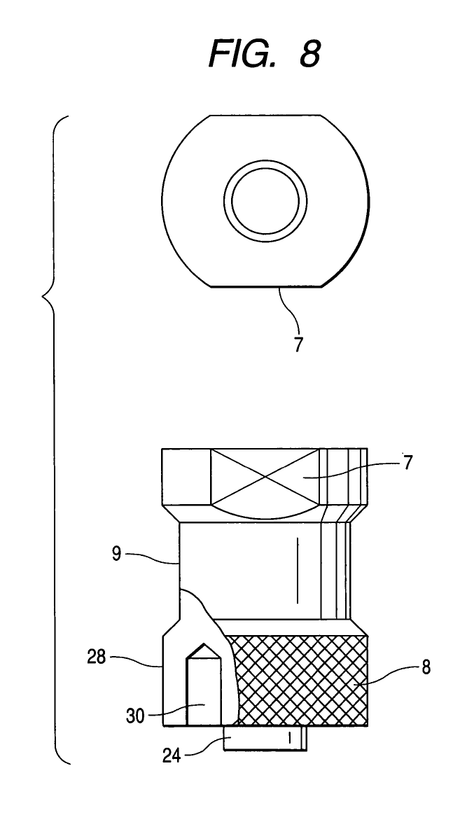

FIGS. 1 to 6 show an embodiment of a nailer 10 of this invention. In these figures, a push lever 15 is slidably arranged on a nose 22 and attached at its upper end to an adjuster 6 by a bolt 23. A projection 24 of the adjuster 6 shown in FIG. 4 is bolted into a hole 35 (FIG. 3) of the push lever 15 by a bolt 23. In this case, since the height H of the projection 24 is slightly larger than the thickness of the push lever 15, the push lever 15 is not tightened and so the adjuster 6 is rotatable. In order to prevent the adjuster 6 from being rotated owing to the shock in nailer driving, a steel ball 26 and a spring 27 are arranged in two grooves 30 which are provided by 180° apart from each other on the one end of the adjuster 6, respectively. The steel ball 26 is always urged toward the push lever 15 by the spring 27 so that it has sunk by about ⅓ in a groove 26 of the push lever 15 in a relationship between the diameter of the steel ball 26 and the radius of the groove of the push lever 15. In order to rotate the adjuster 6 from this state, a running torque must be given to the adjuster 6 against the above load so that the steel balls 26 sunk in the grooves 25 of the push lever 15 float onto the upper surface 33 of the push lever 15. Therefore, the adjuster 6 must be rotated with the rotation gripping portion 28 being firmly gripped by fingers. Since the upper portion of the adjuster 6 is screw-engaged with the push lever 16, when the adjuster 6 is rotated, the gap D between the adjuster 6 and push lever 16 is increased or decreased. Namely, the entire push lever 5 is expanded or contracted. The push lever 5 is always urged by the spring 17 toward the member to-be-drived. As shown in FIGS. 4 to 6, the wrenching portion 7 of the adjuster 6 must have a certain width which permits the torque for tightening the bolt 23 to be received from a wrench. In accordance with this invention, as shown in FIG. 5, the wrenching portion 7 is formed at the rotation gripping portion 28. This makes it unnecessary to provide a large diameter portion separately. Thus, the adjuster 6 itself can be shortened and so the nailer can be downsized. The rotation gripping portion 28, as shown in FIG. 5, is provided with non-slip rugged portions at four positions and formed in a polygonal shape. Therefore, the rotation gripping portion has an outer periphery which is short and effective to rotate the adjuster 6. Further, since the entire length of the adjuster 6 is short, unlike the conventional adjuster, an undercut portion 9 is not required on the way between the rotation gripping portion 28 and the wrenching portion 7. In the case where the adjuster 6 is manufactured by resin molding, since there are a screw-hole 29 for engagement between the push levers 15 and 16 at the central portion and grooves 30 each receiving the spring 27 as shown in FIG. 6, a molding die must be divided in a longitudinal direction. As described above, since the wrenching portion 7 is formed at the rotation gripping portion 28, no undercut is provided at the central portion. Therefore, the molding die can be divided in the longitudinal direction. Further, since the non-slip rugged portions are rugged in only the longitudinal direction, the molding die can be divided in the longitudinal direction.

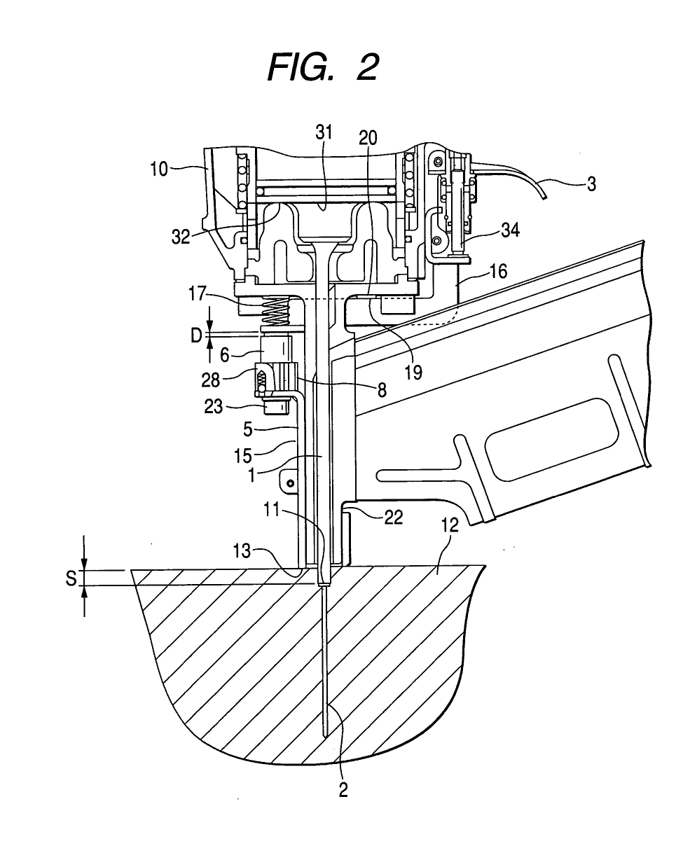

With the configuration described above, nail driving is carried out as follows. In the case where the push lever 5 is raised against the spring 17, which always presses the tip of the push lever 15 onto the member-to-be-drived 12 and hence always urges the push lever 5 toward the member-to-be-drived 12, as shown in FIG. 2, when the touching surface 19 of the push lever 16 is touched to the touching surface 20 of the nose 22, the push lever 5 stops to ascend. Specifically, the upper dead point of the push lever 16 is predetermined. Therefore, the expansion/contraction of the push lever 5 based on the rotating operation of the adjuster 6 adjusts the position of the tip of the push lever 15 vertically. Near the upper dead point, the upper end of the push lever 16 engages with a plunger 34 and pushes up it. In this state, when the switch 3 is pulled, the driver blade 1 drops abruptly. When the touching surface 31 of the piston is touched to the upper surface 32 of a piston bumper, the driver blade 1 stops to drop, thereby driving a nail 2 from an ejection opening 4. The driving depth of the nail 2 is determined by the distance from the tip 11 of the driver blade 1 to the tip 13 of the push lever 15, i.e. the projecting quantity S of the driver blade 1. In the case where the driving depth is made shallow, if the adjuster 6 is rotated to extend the push lever 5 so that the distance D between the push lever 16 and the adjuster 6 is increased, the adjuster 6 and push lever 15 descend so that the projecting quantity S of the tip 14 of the driver blade 1 decreases. Thus, the driving depth decreases.

In accordance with this invention, a wrenching portion is formed at a gripping portion of an adjuster, and the adjuster is formed in a polygonal shape and provided with non-slip rugged portions at several points. The adjuster is also formed in a shape which permits a simple two-part resin molding in a vertical direction. Thus, a driving depth adjusting device can be provided which is compact and lightweight and is easy to operate.

What is claimed is:

1. A nailer comprising:
a nailer body;
a drive blade incorporated in the nailer body;
a switch portion for controlling operation of the driver blade;
a push lever having one end connected to the switch portion and including a plurality of components; and
an adjuster having a gripping portion for rotation and located between the components to increase and decrease entire length of the push lever in an operating direction of the drive blade,
wherein a wrenching portion for bolting is formed at the gripping portion.

2. The nailer according to claim 1, wherein a rugged portion is substantially formed on at least one surface of the gripping portion.

3. The nailer according to claim 2, the gripping portion is formed in a polygonal shape.

4. The nailer according to claim 2, wherein the adjuster is formed in a shape in which no undercut is provided in a longitudinal direction of the adjuster and a rugged portion can be molded in two parts.
